(19) United States
(12) Patent Application Publication
(10) Pub. No.: US 2011/0145766 A1
(43) Pub. Date: Jun. 16, 2011

(54) Conveying dense information in an easily consumable format in a visual model

(75) Inventors: Daniel Berg, Holly Springs, NC (US); Michael D. Elder, Durham, NC (US); John Swanke, Terryville, CT (US)

(73) Assignee: INTERNATIONAL BUSINESS MACHINES CORPORATION, Armonk, NY (US)

(21) Appl. No.: 12/637,854

(22) Filed: Dec. 15, 2009

(51) Int. Cl. G06F 3/048

(52) U.S. Cl. 715/839

(57) ABSTRACT

A method and a system for presenting a semantic model. A semantic diagram of the semantic model can be presented on a display, the semantic diagram including at least one graphical image representing a real world device as an element of the semantic model. When the graphical image is selected by a user, a list including at least one semantic qualifier can be presented on the display. A first user selection of a first semantic qualifier can be received. A first qualifier key can be generated. The first qualifier key can associate the first semantic qualifier with the real world device. The first qualifier key can be persisted to a memory device. The first qualifier key can be processed during a validation routine performed on the semantic model.

### BACKGROUND

The embodiments disclosed within this specification relate to electronic modeling systems. More particularly, the embodiments relate to semantic models of real world device networks.

In a semantic model, devices such as computers and network components are represented as elements within one or more semantic diagrams. These semantic diagrams are oftentimes presented in a graphical modeling editor. In such a diagram, each semantic element can be depicted as a graphical image. To visualize an element's properties, the graphical modeling editor can be used to add icons or text to the diagram. The icons or text typically are connected to the graphical images, or otherwise placed near the graphical images.

These semantic diagrams oftentimes become cluttered with the additional icons or notes that are added. In consequence, the semantic diagrams can become very large, and sometimes become hard to follow.

### BRIEF SUMMARY OF THE INVENTION

The embodiments disclosed within this specification relate to a method for annotating a semantic model, and a system that implements the method. One embodiment of the present invention can include presenting a semantic diagram of the semantic model on a display, the semantic diagram including at least one graphical image representing a real world device as an element of the semantic model. When the graphical image is selected by a user, a list including at least one semantic qualifier can be presented on the display. A first user selection of a first semantic qualifier can be received. A first qualifier key can be generated. The first qualifier key can associate the first semantic qualifier with the real world device. The first qualifier key can be persisted to a memory device. The first qualifier key can be processed during a validation routine performed on the semantic model.

Another embodiment of the present invention also can include a method for annotating a semantic model, and a system that implements the method. The method can include presenting a semantic diagram of the semantic model on a display, the semantic diagram including at least one graphical image representing a real world device as an element of the semantic model. When the graphical image is selected by a user, a list including at least one semantic qualifier can be presented on the display. A first user selection of a first semantic qualifier can be received. The user can be prompted to enter data that is to be a detail of the first qualifier key. The data can be received from the user. A first qualifier key can be generated. The first qualifier key can associate the first semantic qualifier with the real world device and can include the data as the detail of the first qualifier key. The first qualifier key can be persisted to a memory device. The first qualifier key can be processed during a validation routine performed on the semantic model.

Yet another embodiment of the present invention can include a computer program product including a computer-usable medium having computer-usable program code that, when executed, causes a machine to perform the various steps and/or functions described herein.

### BRIEF DESCRIPTION OF THE SEVERAL VIEWS OF THE DRAWINGS

FIG. 1 is a block diagram illustrating a system for annotating a semantic model in accordance with an embodiment of the present invention.

FIG. 2 is a semantic diagram illustrating a semantic model in accordance with an embodiment of the present invention.

FIG. 3 is a first view of a graphical image of an element of the semantic model in accordance with an embodiment of the present invention.

FIG. 4 is a second view of a graphical image of an element of the semantic model in accordance with an embodiment of the present invention.

FIG. 5 is a third view of a graphical image of an element of the semantic model in accordance with an embodiment of the present invention.

FIG. 6 is a fourth view of a graphical image of an element of the semantic model in accordance with an embodiment of the present invention.

FIG. 7 is a fifth view of a graphical image of an element of the semantic model in accordance with an embodiment of the present invention.

FIG. 8 is a sixth view of a graphical image of an element of the semantic model in accordance with an embodiment of the present invention.

FIG. 9 is a flow chart illustrating a method of annotating a semantic model in accordance with an embodiment of the present invention.

### DETAILED DESCRIPTION OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In accordance with the present invention, a semantic diagram (hereinafter “diagram”) can be presented on a display for purposes of constructing semantic models, editing semantic models, annotating semantic models, and the like. The diagram can include a plurality of graphical images, each of which represents a real world device that is an element of the semantic model. The user can associate qualifier keys and other details with the graphical images in order to create an association between the qualifier keys and the real world devices. These qualifier keys and details can be processed during validation of the semantic model(s), for instance to verify that various devices comply with specified computing requirements. The qualifier keys also can be processed to generate useful information about a semantic model when such information is requested. For example, if a report is requested identifying the amount of RAM for each of the devices in the semantic model, information for generating the report can be derived from the qualifier keys.

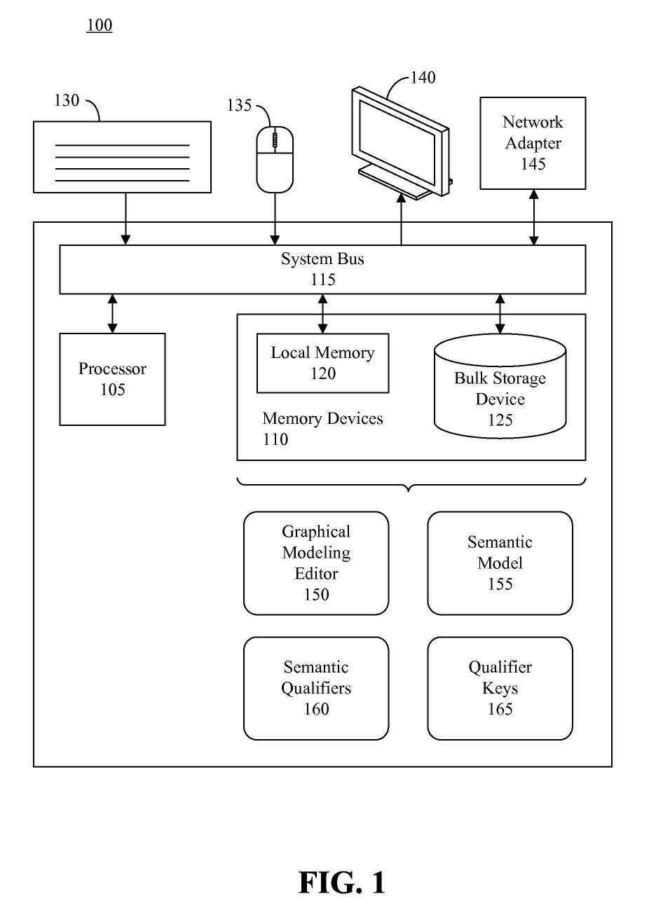

FIG. 1 is a block diagram illustrating a system 100 that may be used to annotate a semantic model in accordance with an embodiment of the present invention. The system 100 can include at least one processor 105 coupled to memory devices 110 through a system bus 115. As such, the system 100 can store program code within the memory devices 110. The processor 105 can execute the program code accessed from the memory devices 110 via system bus 115. In one aspect, for example, the system 100 can be implemented as computer that is suitable for storing and/or executing program code. It should be appreciated, however, that the system 100 can be implemented in the form of any system comprising a processor and memory that is capable of performing the functions described within this specification.

The memory devices 110 can include one or more physical memory devices such as, for example, local memory 120 and one or more bulk storage devices 125. Local memory 120 refers to random access memory or other non-persistent memory device(s) generally used during actual execution of the program code. The bulk storage device(s) 125 can be implemented as a hard drive or other persistent data storage device. The system 100 also can include one or more cache memories (not shown) that provide temporary storage of at least some program code in order to reduce the number of times program code must be retrieved from the bulk storage device 125 during execution.

Input/output (I/O) devices such as keyboard 130, a pointing device 135, and a display 140 also can be coupled to system 100. The I/O devices can be coupled to the system 100 either directly or through intervening I/O controllers. A network adapter 145 also can be coupled to system 100 to enable system 100 to communicate with other systems, computer systems, remote printers, and/or remote storage devices through intervening private or public networks. Modems, cable modems, Ethernet cards, and wireless network adapters, are examples of different types of network adapters that can be used with system 100.

As pictured in FIG. 1, the memory devices 110 can store a graphical modeling editor 150. The graphical modeling editor 150, being implemented in the form of executable program code, can be executed by the system 100 for the purposes of annotating a semantic model 155 in accordance with the methods described herein. Such annotation can be performed during construction of the semantic model, during editing processes performed on the semantic model 155, or at any other desired time. During such annotation, semantic qualifiers 160 may be presented to a user via the display 140, and user selections can be received to generate qualifier keys 165, as will be described herein. The qualifier keys that are generated can be output. As used herein, “outputting” and/or “output” can mean storing in memory devices 110, for example, writing to a file stored in memory devices 110, writing to display 140 or other peripheral output device, playing audible notifications, sending or transmitting to another system, exporting, or the like.

In one embodiment, the qualifier keys 165 can be persisted to a memory device 110 in an extensible markup language (XML) document, a text file, a data table, a hash table, or any other suitable data structure, and associated with all instances of that device in various semantic models. Accordingly, when a device is upgraded, the changes to that device's qualifier keys need only be performed once, regardless of how many different semantic models 155 include that device. Further, the qualifier keys 165 can be processed during validation of the semantic model 155, for instance to verify that various devices comply with specified computing requirements. The qualifier keys 165 also can be processed to generate useful information about a semantic model 155 when such information is requested. For example, if a report is requested identifying the amount of RAM for each of the devices in the semantic model 155, information for generating the report can be derived from the qualifier keys 165.

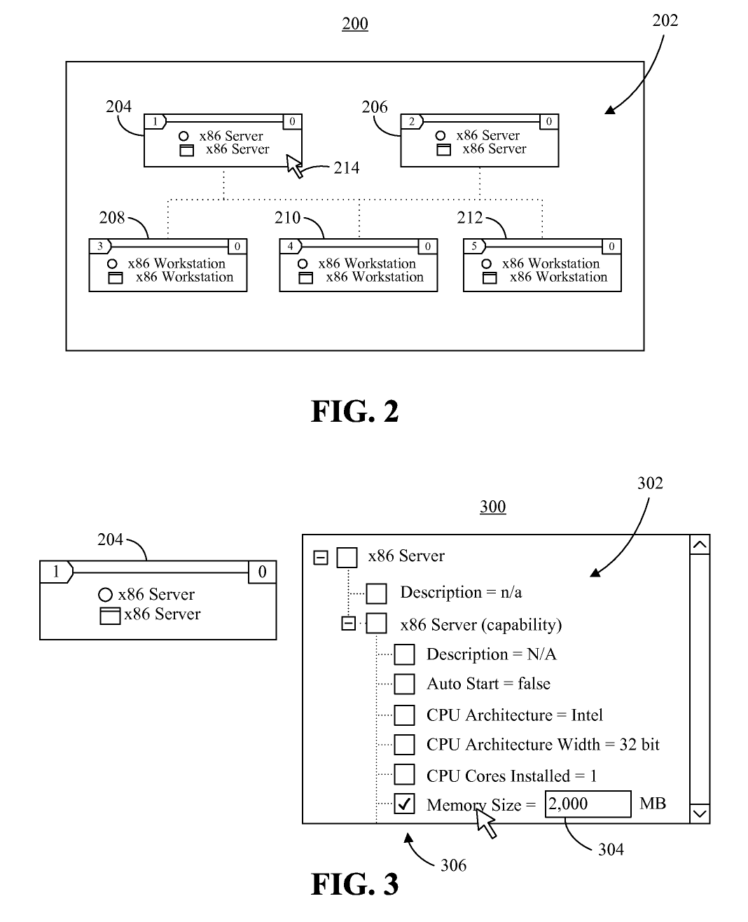

FIG. 2 is a diagram 200 illustrating a semantic model 202 in accordance with an embodiment of the present invention. The diagram 200 can be presented via a user interface of the system, for example on the display. The semantic model 202 can include one or more graphical images 204, 206, 208, 210, 212. As noted, each of the graphical images 204-212 can represent a real world device that is an element of the semantic model. For example, in a semantic model of a computer network, the graphical images can represent servers, workstations, printers, network-attached storage devices, and the like. In other semantic models, the graphical images 204-212 can represent other types of devices, for example televisions, gaming consoles, etc., and the invention is not limited in this regard.

The graphical images can be user selectable so that qualifier keys can be generated and associated with the graphical images. As used herein, a qualifier key is an attribute assigned to a device. In some instances, additional data can be included as details of the qualifier keys. For instance, if a particular qualifier key represents a CPU architecture width, data indicating the particular width (e.g., 16-bit, 32-bit, 64-bit, 128-bit, etc.) can be included as the detail.

In the present example, the graphical image 204 can be selected by the user for the purpose of associating one or more qualifier keys with the device represented by the graphical image 204. For instance, a user can manipulate the pointing device to select the graphical image 204 using a cursor 214. As used herein, the term “user” means a person.

Referring to FIG. 3, in response to the selection of the graphical image 204, a list 300 of semantic qualifiers 302 can be presented. The list 300 can be presented in a window, such as a pop-up window, or in any other suitable manner. From the list 300, the user can select one or more of the semantic qualifiers 302 to generate qualifier keys that associate the semantic qualifiers with the device. For example, a user can select a “Memory Size” qualifier in order to generate a qualifier key that assigns a memory size to the device. Any of a variety of semantic qualifiers 302 can be presented for selection, and the invention is not limited to these examples.

As noted, certain qualifier keys may have additional details associated with them. In illustration, when the “Memory Size” qualifier is selected, an input field 304 can be activated to receive data from the user pertaining to the amount of memory that is to be assigned to the device. Within the input field 304, the user can enter the amount of RAM within the device, and this value can be included as detail of the qualifier key. The user can enter the data using a keyboard, or can select suitable data from a list of applicable data. For example, when “Memory Size” is selected, a list (not shown) of available memory sizes can be presented to the user, and the user can select a value from the list.

In addition, a selectable field 306 can be presented with each semantic qualifier 302 to indicate which qualifier keys are to be presented in the diagram. For instance, if the user desires the “Memory Size” qualifier key to be presented, the user can select the display field 306 of the “Memory Size” semantic qualifier 302. The display field 306 can be a check box, and can be selected by the user to toggle between the display field 306 being checked, in which case the Memory Size qualifier key is to be presented in the diagram, and the display field 306 being unchecked, in which case the Memory Size qualifier key is not to be presented in the diagram, but nonetheless is still associated with the device. The qualifier keys that are selected to be presented in the diagram can be presented in any suitable manner, as will be described.

In some instances, it may be desirable to not include certain types of qualifier key details. In such cases, default data such as “N/A” can be entered or selected as the qualifier key detail. In one embodiment, the list 300 can be editable. Semantic qualifiers 302 that are not desired can be removed from the list 300, and additional semantic qualifiers 302 that are desired can be added to the list 300. The addition and removal of semantic qualifiers 302 can be performed in any suitable manner, for example using an edit or tool menu (not shown). In another embodiment, the list 300 can be customized for each semantic model. Once configured, the list 300 can be used as a default list for each of the devices represented in the semantic model.

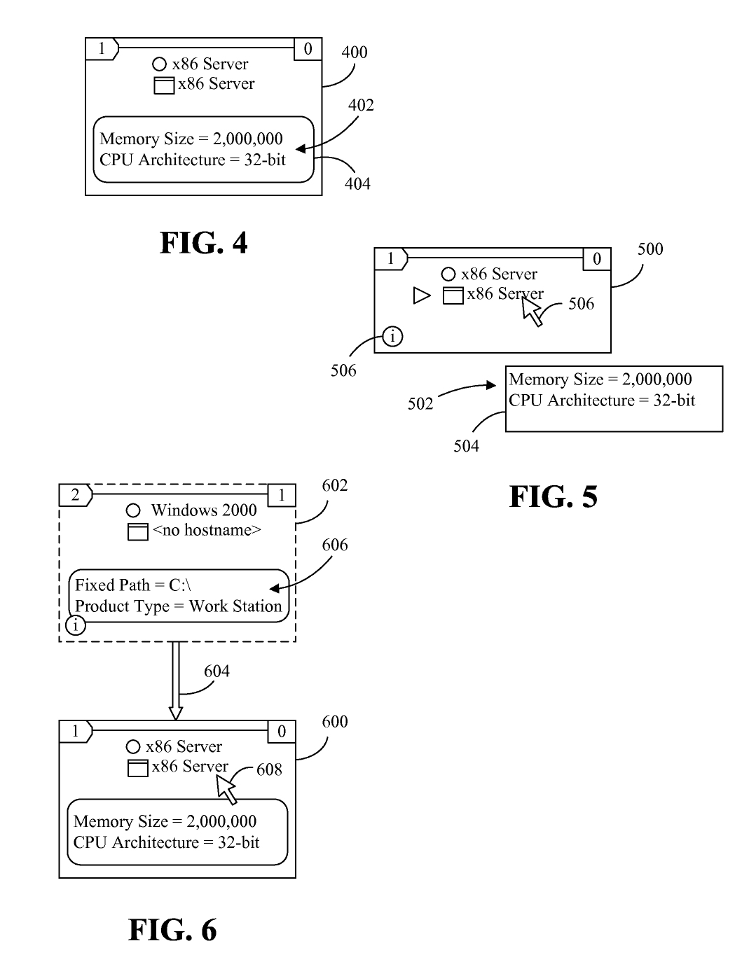

FIG. 4 is a view of a graphical image 400 of an element of the semantic model in which a plurality of qualifier keys have been associated with the device. In this embodiment, one or more of the qualifier keys 402 can be presented in a text box 404 that is placed inside the graphical image 400. These qualifier keys 402 can be the qualifier keys for which the corresponding display field has been selected.

In other examples, the qualifier keys can be presented in a display window (e.g., as a tool tip) when a cursor is placed over the graphical image, or placed within the diagram as a display field, for example within a box proximately located to the graphical image. In an embodiment in which a display field is used, the display field can be connected to the graphical image using a line, or any other suitable indicator. As noted, one or more of the qualifier keys generated for a device can be presented in the graphical image. For example, the user can select display properties of the qualifier keys to indicate whether the qualifier keys are to be presented within the graphical image. Further, when an element of the semantic model is to be embedded within another element, the qualifier keys can be presented in the graphical image corresponding to the other element.

FIG. 5 is another view of a graphical image 500 of an element of the semantic model in which a plurality of qualifier keys have been associated with the device. In this embodiment, one or more of the qualifier keys 502 can be presented in a text box 504 that is presented outside the graphical image 500. Again, these qualifier keys 502 can be those for which the display properties have been selected to indicate that the qualifier keys 502 are to be presented. In one aspect of this embodiment, the text box 504 can be presented as a tool tip. For instance, the text box 504 can be presented when a cursor 506 is placed over the graphical image 500. Tool tips are known to the skilled artisan.

In one embodiment, an indicator such as an icon can be presented in the graphical image 500 to indicate that additional information, such as one or more qualifier keys, associated with the device is available for viewing.

FIG. 6 is another view of a graphical image 600 of an element of the semantic model in accordance with an embodiment of the present invention. In this arrangement, another element of the semantic model can be associated with the device represented by the graphical image 600. For example, a graphical image 602 representing an operating system resident on the device can be placed near the graphical image 600, and a suitable indicator 604 can be placed in the diagram to represent the relationship between the operating system and the device.

Qualifier keys 606 can be associated with the operating system. For example, qualifier keys 606 can be assigned to the operating system to indicate where the operating system is located on the device and to indicate an operating system type. Still, any of a myriad of other qualifier keys 606 can be assigned and the invention is not limited in this regard.

The graphical image 602 and indicator 604 can remain displayed on the diagram, for example as shown, or the graphical image 602 and indicator 604 can be selectively presented in the display. For instance, the graphical image 602 and indicator 604 can be presented when the graphical image 600 is selected with a cursor 608, or when the cursor 608 is placed over the graphical image 600.

In one aspect of the present invention, additional qualifier keys (not shown) can be generated to associate the other element with the device. These qualifier keys also can be persisted to a suitable memory device. For example, the qualifier keys can be maintained in a file in which other qualifier keys generated for the device are stored.

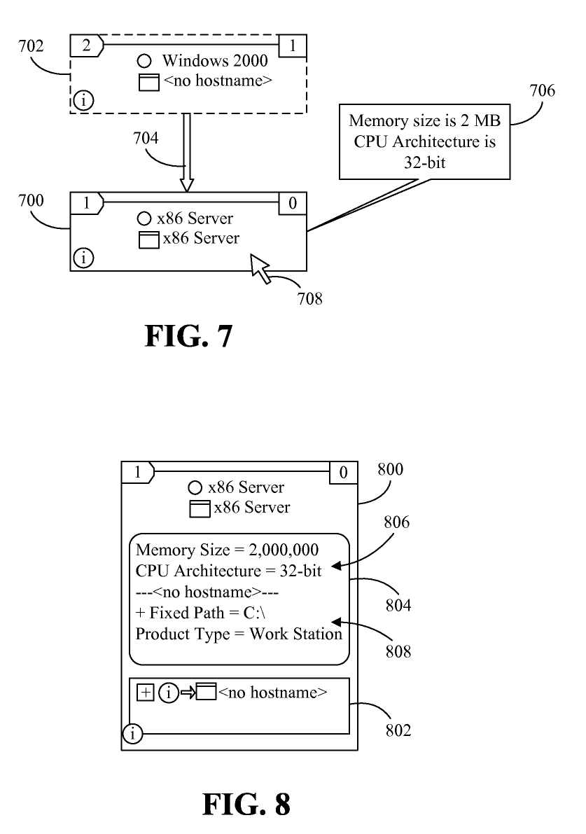

FIG. 7 is another view of a graphical image 700 of an element of the semantic model in accordance with an embodiment of the present invention. In this arrangement, the graphical images 700, 702 can be presented in a manner that indicates that the element represented by the graphical image 702 is associated by the device represented by the graphical image 700, for instance using the indicator 704. In contrast to the example of FIG. 6, however, rather than displaying the qualifier key information within the graphical images 700, 702, such information can be presented in a text box 706 (e.g., a tool tip) when a graphical image 700, 702 is selected or a cursor 708 is placed over a graphical image 700, 702.

FIG. 8 is another view of a graphical image 800 of an element of the semantic model in accordance with an embodiment of the present invention. In this embodiment, a graphical image 802 for another element of the semantic model, for example the operating system previously discussed, can be embedded within the graphical image 800. In one aspect, the text box 804 can present not only qualifier keys 806 assigned the device, but also qualifier keys 808 assigned to the other element. In another embodiment, the qualifier keys 808 can be presented in a text box within the graphical image 802.

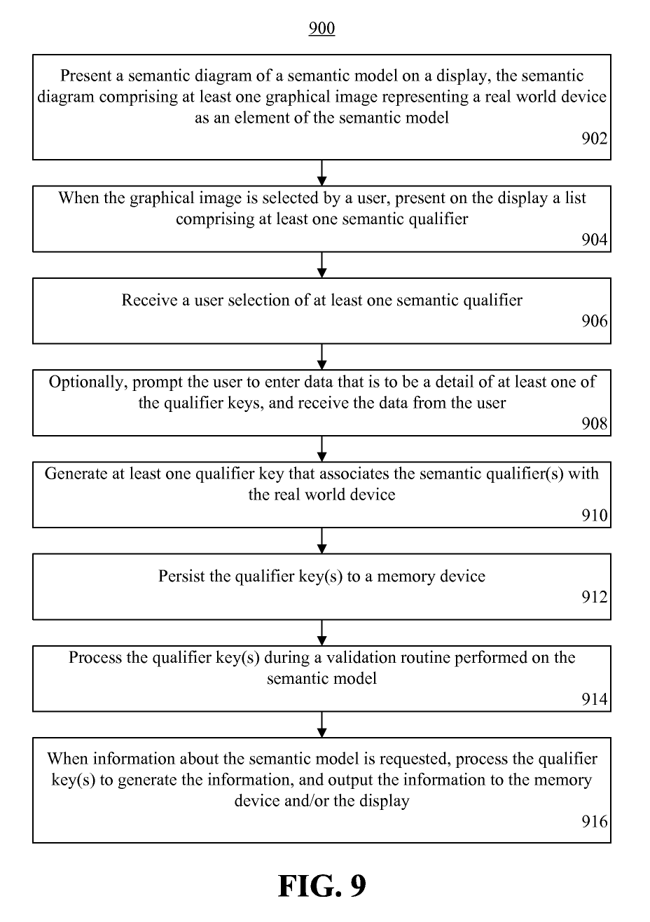

FIG. 9 is a flow chart illustrating a method 900 of annotating a semantic model in accordance with an embodiment of the present invention. At step 902, a semantic diagram of the semantic model can be presented on a display. The semantic diagram can comprise at least one graphical image representing a real world device as an element of the semantic model.

At step 904, when the graphical image is selected by a user, a list comprising at least one semantic qualifier can be presented on the display. At step 906, a user selection of at least one semantic qualifier can be received. Optionally, at step 908, the user can be prompted to enter data that is to be a detail of at least one of the qualifier keys, and the data can be received from the user.

At step 910, at least one qualifier key can be generated. The qualifier key can associate the semantic qualifier(s) with the real world device. At step 912, the qualifier key(s) can be persisted to a memory device. At step 914, the qualifier key(s) can be processed during a validation routine performed on the semantic model. At step 916, when information about the semantic model is requested, the qualifier key(s) can be processed to generate the information, and the information can be output to the memory device and/or the display.

Like numbers have been used to refer to the same items throughout this specification. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method of annotating a semantic model, the method comprising:
presenting a semantic diagram of the semantic model on a display, the semantic diagram comprising at least one graphical image representing a real world device as an element of the semantic model;
when the graphical image is selected by a user, presenting on the display a list comprising at least one semantic qualifier;
receiving a first user selection of a first semantic qualifier;
generating a first qualifier key that associates the first semantic qualifier with the real world device;
persisting the first qualifier key to a memory device; and
processing the first qualifier key during a validation routine performed on the semantic model.

2. The method of claim 1, further comprising:
when the first semantic qualifier is selected by the user, prompting the user to enter data that is to be a detail of the first qualifier key; and
receiving the data from the user;
wherein generating the first qualifier key comprises including the data as the detail of the first qualifier key.

3. The method of claim 1, further comprising:
when information about the semantic model is requested, processing the first qualifier key to generate to generate the information; and
outputting the information to at least one device selected from the memory device and the display.

4. The method of claim 1, further comprising:
presenting the first qualifier key in a display field positioned proximate to the graphical image on the display.

5. The method of claim 1, further comprising:
when a cursor is placed over the graphical image, presenting the first qualifier key in a display window positioned proximate to the graphical image on the display.

6. The method of claim 1, further comprising:
presenting the first qualifier key in the graphical image.

7. The method of claim 1, further comprising:
when the element of the semantic model is embedded within a second element of the semantic model, presenting the first qualifier key in a second graphical image corresponding to the second element.

8. The method of claim 1, wherein the list comprises a plurality of semantic qualifiers, the method further comprising:
receiving a second user selection of at least a second semantic qualifier;
generating a second qualifier key that associates the second semantic qualifier with the real world device;
persisting the second qualifier key to the memory device; and
processing the second qualifier key during the validation routine performed on the semantic model.

9. The method of claim 8, further comprising:
receiving a user selection of a display property of at least one semantic qualifier selected from a group consisting of the first semantic qualifier and the second semantic qualifier;
selectively presenting the first qualifier key or the second qualifier key in the graphical image based on the user selection of the display property.

10. A computer-implemented method of annotating a semantic model, the method comprising:
presenting a semantic diagram of the semantic model on a display, the semantic diagram comprising at least one graphical image representing a real world device as an element of the semantic model;
when the graphical image is selected by a user, presenting on the display a list comprising at least one semantic qualifier;
receiving a first user selection of a first semantic qualifier;
prompting the user to enter data that is to be a detail of a first qualifier key that associates the first semantic qualifier with the real world device;
receiving the data from the user;
generating the first qualifier key, the first qualifier key including the data as the detail of the first qualifier key;
persisting the first qualifier key to a memory device; and
processing the first qualifier key during a validation routine performed on the semantic model.

11. The method of claim 10, further comprising:
when information about the semantic model is requested, processing the first qualifier key to generate to generate the information; and
outputting the information to at least one device selected from the memory device and the display.

12. The method of claim 10, further comprising:
presenting the first qualifier key in a display field positioned proximate to the graphical image on the display.

13. The method of claim 10, further comprising:
when a cursor is placed over the graphical image, presenting the first qualifier key in a display window positioned proximate to the graphical image on the display.

14. A computer program product comprising:
a computer-usable medium comprising computer-usable program code that, when executed by a computer, annotates a semantic model, the computer-usable medium comprising:
computer-usable program code that presents a semantic diagram of the semantic model on a display, the semantic diagram comprising at least one graphical image representing a real world device as an element of the semantic model;
computer-usable program code that, when the graphical image is selected by a user, presents on the display a list comprising at least one semantic qualifier;
computer-usable program code that receives a first user selection of a first semantic qualifier;
computer-usable program code that generates a first qualifier key that associates the first semantic qualifier with the real world device;
computer-usable program code that persists the first qualifier key to a memory device; and
computer-usable program code that processes the first qualifier key during a validation routine performed on the semantic model.

15. The computer program product of claim 14, the computer-usable medium further comprising:
computer-usable program code that, when information about the semantic model is requested, processes the first qualifier key to generate to generate the information; and
computer-usable program code that outputs the information to at least one device selected from the memory device and the display.

16. The computer program product of claim 14, the computer-usable medium further comprising:
computer-usable program code that presents the first qualifier key in a display field positioned proximate to the graphical image on the display.

17. The computer program product of claim 14, the computer-usable medium further comprising:
computer-usable program code that, when a cursor is placed over the graphical image, presents the first qualifier key in a display window positioned proximate to the graphical image on the display.

18. The computer program product of claim 14, the computer-usable medium further comprising:
computer-usable program code that presents the first qualifier key in the graphical image.

19. The computer program product of claim 14, the computer-usable medium further comprising:
computer-usable program code that, when the element of the semantic model is embedded within a second element of the semantic model, presents the first qualifier key in a second graphical image corresponding to the second element.

20. The method of claim 14, wherein the list comprises a plurality of semantic qualifiers, the computer-usable medium further comprising:
computer-usable program code that receives a second user selection of at least a second semantic qualifier;
computer-usable program code that generates a second qualifier key that associates the second semantic qualifier with the real world device;
computer-usable program code that persists the second qualifier key to the memory device; and
computer-usable program code that processes the second qualifier key during the validation routine performed on the semantic model.
